(19) United States
(12) Patent Application Publication
(10) Pub. No.: US 2012/0191977 A1
(43) Pub. Date: Jul. 26, 2012

(54) SECURE TRANSACTION FACILITATOR

(75) Inventors: David Ventres Foster, Winchester, VA (US); John Michael Foster, Winchester, VA (US); Jacob Gates Foster, Chicago, IL (US)

(73) Assignee: MERQUERY FINANCIAL SYSTEMS, LLC, Winchester, VA (US)

(21) Appl. No.: 13/013,140

(22) Filed: Jan. 25, 2011

(51) Int. Cl. H04L 9/32

(52) U.S. Cl. 713/170

(57) ABSTRACT

A method, system, and devices are provided in which modified digital signatures are used to provide a dynamically generated number suitable for use in transactions requiring validation. The method uses symmetric key encryption to encode a message comprising authorization information and may use compression algorithms to provide a truncated message digest such that the dynamic number may be processed by existing credit card or other authorization systems. In part, this method is an improvement over other validation methods as decryption, which requires greater computing power, is not required. The method may be performed through the use of various devices. For example, credit cards may utilize the method to dispose the dynamic number in a magnetic strip or to transmit the dynamic number via radio transmitter. Smart cards, smart phones, or USB devices, optionally may be utilized to perform the inventive method.

### BACKGROUND

The present invention relates to a method, system, and devices for use in validating transactions.

The repeated use of a single identifying number creates the primary vulnerability of current credit card processing systems to fraud. Currently, merchants must use this number to authorize a transaction. Most merchants also retain a copy of the number for at least a short time, to protect themselves against lost revenue due to charge-backs. Because the information needed to validate a current transaction is the same information needed to falsify future transactions, any person with access to the number may successfully initiate fraudulent transactions. Thus, credit fraud is easily facilitated by skimming a lost or stolen credit card, accessing business records, or phishing account numbers online. Billions of dollars per year are fraudulently charged by simple methods such as these. Accordingly, a solution is needed to reduce fraud carried out by these and similar methods.

Strong authentication and encryption systems, based on advanced cryptography, digital signatures, and a public key infrastructure (“PKI”), have been developed and implemented. These systems are well-known and provide very good protection from fraudulent transactions. Digital signatures allow the recipient of a message to verify the identity of the author. These systems are based on keys that, using current technology, typically would take decades to reconstruct even using supercomputers and if the digital signatures were intercepted thousands of times.

PKI-based authentication systems generally use asymmetric encryption algorithms using a combination of a public key, which is shared, and private key, which is not shared. The output of encryption using the private key is known as cipher text. A person wanting to verify that a cipher text was encrypted using a particular private key must decrypt the entire cipher text. Using asymmetric encryption, if the cipher text is altered in any way, it is not presently feasible to decrypt the cipher text or verify the identity of the user based on his private key.

Communication of conventionally asymmetrically encrypted digital signatures comprising the entire cipher text typically requires at least a moderate amount of bandwidth. Although not excessive from a superficial perspective, the required bandwidth still exceeds that available in many existing authentication systems (e.g., standard credit card and identity card readers).

In contrast to asymmetric encryption, symmetric encryption, as referred to herein, uses shared keys rather than public and private keys, and allows for a cipher text to be truncated yet remain verifiable. Thus, it is desirable to use symmetric encryption, specifically systems wherein each of the parties has access to an identical private key (even if the process otherwise might be considered asymmetric), when a cipher text must be truncated before being communicated between a user requesting authentication and a receiver wanting to verify the user or when it is desirable to reduce the bandwidth of such transmissions.

PKI-based systems typically are complex to implement. Typically, they require many participants and systems to verify the digital signature of a user making a transaction. Thus, though the cryptography on which PKI systems are based can provide a high-level of confidence in a transaction, these systems have had limited commercial application.

Businesses also have not generally moved to implement devices using methods such as external and internal timing mechanisms to generate dynamic numbers. These proposed but unpopular devices typically share such disadvantages as timing errors and continuous generation of numbers, which increase the likelihood of a repeated number. Further, both the user and remote authenticator must synchronize their communications based on a third party timing signal. These devices, like unmodified PKI-based systems, are also complex to implement fully and accurately because of their dependence on third parties and have had limited commercial application.

The disadvantages of PKI and other complex systems are especially inconvenient for credit and other high-volume authorization transactions where bandwidth and the computing power of embedded devices are very limited. Therefore, it is desirable to implement less complex methods and devices that retain the fraud prevention advantages of digital signatures, but utilize technology in a way that requires little computing power, bandwidth, or third-party interaction.

It already is known how to replace a traditional credit card with a device that can create a more fully secure transaction by eliminating the repeated use of one number. For example, “smart card” credit cards from several processing companies perform this function. However, these and similar devices ordinarily require that merchants replace existing card authorization equipment. Businesses are hesitant to take on such an expense. For this reason, it would be desirable to find a means for preventing fraud while retaining the existing equipment for authorization systems.

In many current authorization card readers, a magnetic strip is used which contains the user's name, identity number, and other authorization information. For example, in a credit card the standard format requires the user's name, credit card number, and expiration date. Consumers are accustomed to swiping their cards in order to allow the magnetic strip to be read, and authentication systems presently exist that comprise reading and transmitting digital data obtained from magnetic strips. Thus, it is desirable in credit card transactions to use a magnetic strip compatible with currently installed equipment. However, most magnetic strips contain static data and hence are vulnerable to fraudulent data capture and misuse. To improve security, it would be desirable to reduce dependence on such static data while utilizing media capable of being read by existing magnetic strip readers.

### SUMMARY

A method of using modified digital signatures generates a non-repeating dynamic number for authenticating credit and other transactions. Thus, small, but secure, digital signatures may be created, which may be transmitted over existing low-bandwidth connections and may be confidently authenticated.

One example of the inventive method for facilitating a secure transaction requires each of a user (the party requesting or whose transaction requires authentication) and a receiver (for example, a system comprising a processor and memory for data storage) to have access to a private digital key.

In this example, at the user end of the transaction, a digital user message is created. The digital message comprises user-identifying data and data relating to the user's transaction. For example, in a standard credit card transaction, the user-identifying data may be an account number, and the data relating to the user's transaction may be the time and date of the transaction. Alternatively, data such as an account holder's name, a personal identification number (“PIN”), an expiration date, or other data might identify the user, and the amount to be charged, merchant name, or other data might relate to the transaction. Then, at least a part of the data comprising the digital message is encrypted using the private key and an encryption program to create a first encrypted digital digest, which for convenience may be thought of as a digital signature or as a Temporary Account Number (“TAN”). The authorization request comprising the digital user message and TAN may be sent to an authorization processing center, which can use the TAN and the other data elements to verify the authenticity of the transaction.

In one example, the receiver system receives the authorization request and locates and processes the user-identifying information contained in the digital user message to identify the private key relevant to the transmission. The receiver system then retrieves the private key from the data storage location and begins the analysis process.

In this example, however, and in contrast to conventional technology, the receiver does not need to decrypt the user's transmission to verify its authenticity. Instead, an encryption process may be utilized. Persons skilled in the art will appreciate that a compressed cipher text cannot be decrypted because some information will have been lost. However its authenticity can still be verified by repeating the encryption procedure.

To utilize the encryption comparison method of this example, the receiver generates a second encrypted digital digest in the same manner in which the user created the first encrypted digital digest—that is, the receiver encrypts at least a part of the data comprising the digital message (the same part that was encrypted by the user) using the private key and an encryption program. Then, to determine the authenticity of the user transmission, the receiver compares the second encrypted digital digest that was created by the receiver, with the first encrypted digital digest (the TAN) that came from the user. If the two match, the transaction is authentic.

The digital signature comprising the TAN may be generated by combining several authorization data elements. Preferably the data elements are selected so that the ultimately-resulting TAN will be generated in part by a dynamic element relating to the transaction—for example, transaction date and time, which of course will change from transaction to transaction. Including such dynamic elements in the user message itself, whether or not selected as a basis for the TAN, reduces the timeframe during which fraudulent attempts may be made by replaying a previously skimmed TAN.

The private key utilized by the user and the receiver may be stored in a single location accessible to each of them, or may exist in duplicates that are separately stored.

The elements that comprise the TAN may be hashed, typically prior to encryption. In such cases, the hashed digest may be encrypted using the shared encryption key to produce the digital signature comprising the TAN. The encryption process may utilize any symmetric or asymmetric encryption algorithm.

The digital signature comprising the TAN may be further shortened to a desired number of digits using a compression algorithm. Alternatively, the digest may be compressed using appropriately chosen modular arithmetic. As another example, another hash function may be used to map the first hashed digest to a number of desired length.

Thus, in an exemplary embodiment, the user may transmit a first TAN and the data elements from which it has been derived to a receiver. The receiver may use some or all of the data elements, for example the account name, to retrieve the hash function, shared key, and compression function used by the sender to derive the first TAN. The receiver may then apply the hash function, encryption algorithm using the shared key, and the compression function in the same way as the user to compute a second shortened digital signature comprising a second TAN. The receiver may compare the second TAN to the received first TAN. If the first TAN and second TAN match, the receiver may authorize the transaction; if the first TAN and second TAN do not match, the receiver may decline the transaction.

In certain embodiments of devices utilizing the method, the digital signatures may be provided on a magnetic strip of a credit card, the magnetic strip being dynamically programmable and adapted to be programmed by a cryptographic processor. Preferably, the programming of the digital signature and other data encoded on the magnetic strip maps such data to positions that emulate those expected by existing merchant reader equipment. In alternative embodiments, signatures may be transmitted to a receiver or to an intermediate processing device such as an RFID credit card reader by radio frequency rather than a magnetic strip. Transmission may also be accomplished through near field communication, a wireless Internet connection, Bluetooth technology, or any other communication protocol. In still other embodiments, a smart-card or smart-phone with a magnetic strip accessory may be used to produce a digital signature. Other embodiments may feature a combination of software and a USB interfacing device containing a processor, other circuitry, and means for providing the dynamic number directly to a user's internet browser for completing secure online transactions.

### BRIEF DESCRIPTION OF THE DRAWINGS

FIG. 1 is a process flow chart depicting an embodiment of the inventive method.

FIG. 2 is a process flow chart reflecting an embodiment of a device using the inventive method in sending information in a credit transaction.

FIG. 3 is a process flow chart reflecting an example use of the inventive method in receiving information in a credit transaction.

FIG. 4 is a process flow chart reflecting an embodiment of a smart phone using the inventive method through utilizing a smart phone application and device to complete the sender portion of the inventive method.

FIGS. 5A and 5B depict the front and back of an exemplary smart phone and accessory configured to use the inventive method.

FIG. 6 depicts a laptop and accessory configured to use the inventive method.

### DETAILED DESCRIPTION

In the following detailed description of embodiments of the invention, reference is made to the accompanying drawings which form a part hereof, and in which are shown by way of illustration specific embodiments in which the invention may be practiced. It is to be understood that other embodiments may be utilized and structural changes may be made, all without departing from the scope of the present invention.

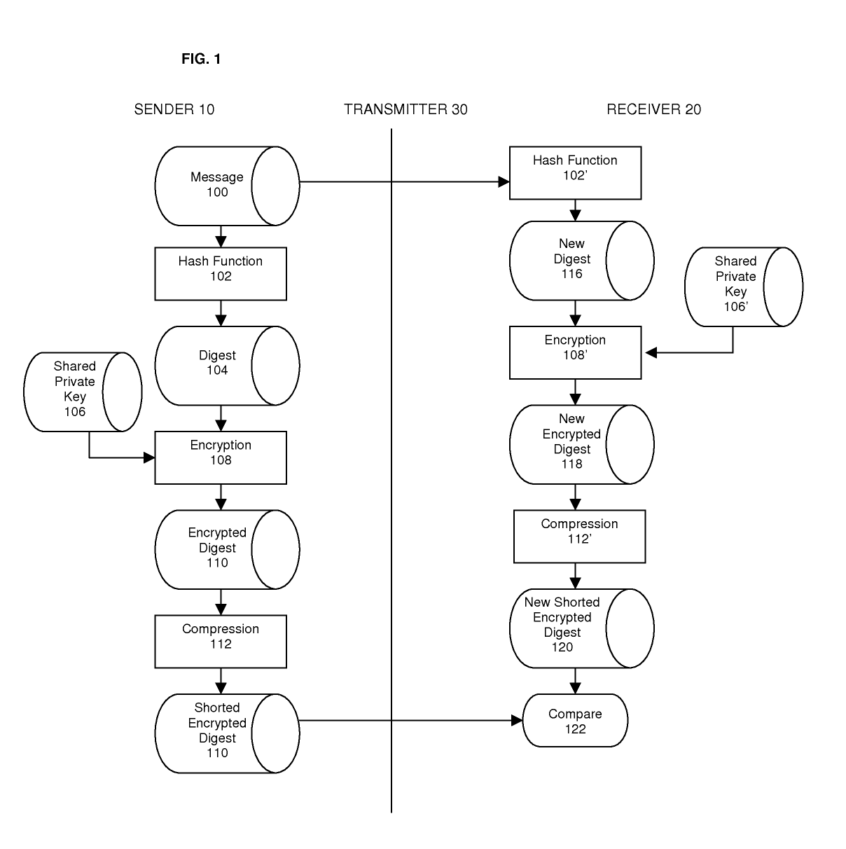

FIG. 1 is a flowchart depicting an embodiment of the inventive method, comprising a sender 10, a receiver 20, and a transmitter 30. It is assumed in the description to follow that the sender 10 is an authorized user of the information manipulated by the inventive method.

The sender 10 has a message 100, which may comprise various data elements. Persons skilled in the art will appreciate that the data elements may comprise any information. The data may be comprised of random numbers or may instead be comprised of an account number, time and date of the transaction, an account holder's name, a personal identification number (“PIN”), an expiration date, an amount to be charged, other data, or some combination thereof.

First, a hash function 201 may be performed on the message 100. The hash function, as the term is used herein, may be any well-defined procedure or mathematical function that converts a large, possibly variably-sized amount of data into a small datum. Through this process, the message 100 is transformed into digest 104, a new string of data.

Next, the digest 104 undergoes encryption 108. The encryption 108 will make use of a shared private key 106. In preferred embodiments, shared private key 106 will be known by, and only by, the sender 10 and the receiver 20. Shared private key 106 should be any data of suitable length for use in encryption process 108. For example, in credit card applications, shared private key 106 may be any data which compromises enough characters to ensure security and to encrypt the name, date, and time up to the minute, as well as any additional information (PIN, expiration date, service code, and other data). Shared private key 106 may be 256 bits long.

The encryption 108 may be of any type. In an exemplary embodiment, the encryption 108 is symmetric, such as, for example, the Advanced Encryption Standard (“AES”) with a 256 bit key. In another embodiment, the encryption 108 may be an RSA scheme, which is an algorithm for public-key cryptography. The encryption 108 of the digest 104 results in an encrypted digest 110, a new set of data.

Through compression 112, the encrypted digest 110 may be truncated to a suitable length, forming a shorted encrypted digest 114. Compression 112 may use any mathematical function, such as a modular arithmetic or hashing function, which creates a datum of smaller length. In embodiments for credit transactions, shorted encrypted digest 114 may be, for example, up to 19 characters long.

The sender 10 may then utilize the transmitter 30 to transmit message 100 and shorted encrypted digest 114 to the receiver 20. The transmitter 30 may use any suitable medium, network, or protocol for communication of digital data. For example, the transmitter 30 may comprise a card reader to read the message 100 and digest 114 from a card and transmit that information using a network. More specifically, the transmitter 30 may use the Internet network as a medium and the TCP/IP protocol.

The receiver 20 will accept delivery of the message 100 and shorted encrypted digest 114 from the transmitter 30. The receiver 20 will perform the exact same process on the message 100 that the sender 10 did before transmitting the message 100 and shorted encrypted digest 114. The message 100 will be transformed to a new digest 116 through the hash function 102′. Then, using the shared private key 106′, the digest 116 will be processed by encryption 108′, which creates a new encrypted digest 118. The new encrypted digest 118 undergoes compression 112′ to be transformed into a new shorted encrypted digest 120.

The receiver 20 may then perform a comparison 122 of shorted encrypted digest 114 against new shorted encrypted digest 120. If digest 114 and digest 120 are identical, the receiver 20 may authorize the transaction assuming there are no other reasons to decline the transaction. If digest 114 and digest 120 are not identical, the receiver 20 may decline the transaction. Then the receiver 20 may transmit notice to the sender 10 via the transmitter 30 that the transaction has been authorized or declined. A person skilled in the art will appreciate that processes 102, 108, and 112 must be operatively identical to processes 102′, 108′, and 112′, respectively, in order for the verification to properly function.

The receiver 20 may execute further processes based on finding that the transaction is authorized or declined. For example, the receiver 20 may record that the transaction was authorized and an amount in a database, the receiver 20 may notify a third-party that the transaction was authorized or declined and an amount authorized, and/or the receiver 20 may freeze the account of the sender 10 if the transaction is declined.

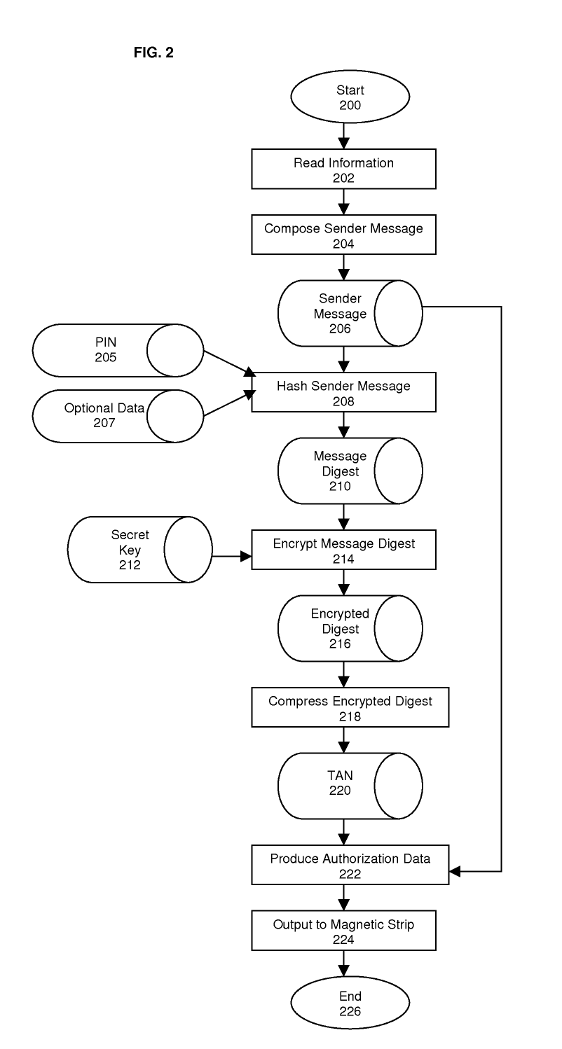

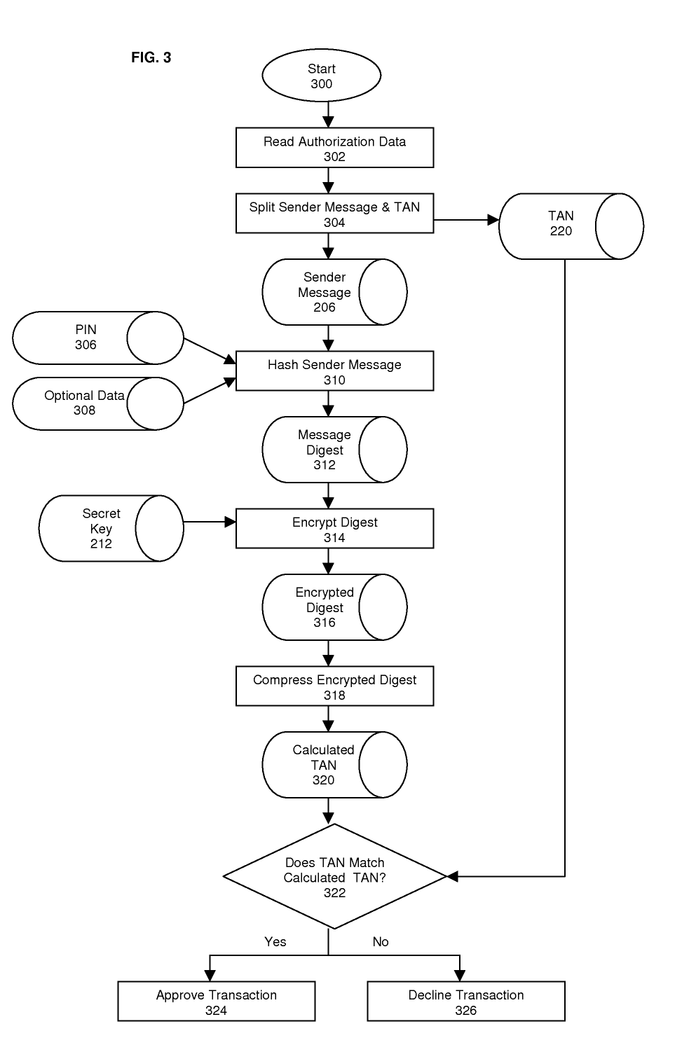

The inventive method may be utilized in various types of transactions, such as identity or credit card transactions. FIGS. 2 and 3 reflect an exemplary embodiment of the inventive method as it might be used for a credit card transaction, with FIG. 2 demonstrating the process from the point of view of a sender and FIG. 3 demonstrating the process from the point of view of a receiver.

In this particular exemplary embodiment, it is contemplated that software instructions executing in the processor or other circuitry disposed in a credit card belonging to the sender may perform the functions comprising the steps in FIG. 2. For example, the process may be performed by software instructions and integrated devices disposed in a “smart chip” or “smart card.” A smart card may comprise an interface configured to connect to a physical layer of an integrated circuit card terminal, a communication interface configured to communicate with a communication device, and an integrated circuit chip. The integrated circuit chip, or smart chip, may comprise control circuitry for managing the operations of the chip, a digital storage location, a communication interface connected to the control circuitry, a symmetric cryptographic processor to perform encryption steps, and an interface for transmitting to a receiver. The communication interface may be configured to communicate with a communication device and to receive data concerning the transaction from at least one of the user, a processor processing the transaction, and a user accessible digital storage location The credit card may further provide an input device, such as a button, which causes instructions to be executed in the processor disposed in the card to begin executing the exemplary process of FIG. 2.

At the start 200, the first step 202 is to read information from the credit card of sender 10, such as the cardholder name, bank code, personal account number (“PAN”), and the date and time (including hours, minutes and seconds). The PAN may be a four-digit secret numeric password or personal identification number (“PIN”). The PIN may be input using a keypad disposed on the credit card or an external keypad that communicates with card or with the card reader. Alternatively, the PAN may be an account number representing a static credit card account number. Persons skilled in the art will appreciate that a PAN comprising a static credit card number may be used with credit card processors that do not support non-repeating account numbers or a temporary account number (“TAN”) as described in more detail below. Other information, such as a card issuer number, may also be obtained from the credit card. The credit card will provide this information from memory located on the card or from another digital storage location, for example a remote location accessible through an input device disposed on or in the credit card. For example, the credit card may comprise a processor, secure memory, and a power source, such as a battery.

The second step 204 is to compose a message from the data elements read in step 202 to produce sender message 206. For example, the message text may be the string concatenation of the data elements in any order.

In the exemplary embodiment, the third step 208 is to hash sender message 206. This hashing may use the WHIRLPOOL hashing function or any other suitable hashing function. A PIN 205 and/or other optional data 207 may also be used in hashing. The result of step 208 is message digest 210.

The fourth step 214 is to encrypt the message digest 210 using an encryption algorithm based on secret key 212. Any type of encryption, symmetric or asymmetric, may be used. An example symmetric encryption algorithm is the AES 256 encryption algorithm; an example asymmetric algorithm is RSA encryption. The result of this step is encrypted digest 216. Persons skilled in the art will appreciate that secret key 212 must be available to both sending and receiving parties in an authorization transaction who wish to use a digital signature to verify a transaction. This can be accomplished by providing each party with access to the same copy of the key, or each party may have its own identical copy of the key.

The exemplary embodiment further includes step 218 in which encrypted digest 216 is truncated to produce a shortened encrypted digest to be used as a non-repeating temporary account number (“TAN”) 220. Step 218 may use any compression function suitable to produce the TAN 220 based on shortening the length of encrypted digest 216 to one which can be used in a credit card transaction. For example, the TAN 220 produced may be up to 19 characters long for credit card transactions that accommodate such lengths. In some embodiments, the TAN 220 may be 10 characters long to match the length of current static credit card numbers. Alternatively, TAN 220 may be longer than 19 characters long. Persons skilled in the art will appreciate that shorter digital signatures require less bandwidth to transmit, but also may be less secure, and appropriate tradeoffs may be made to accommodate those considerations as well as expectations of existing readers with which the process will be used.

The exemplary process may include step 222 during which the sender message 206 and the TAN 220 may be assigned to data elements traditionally representing credit card authorization data. For example, where existing credit card authorization apparatus expects a 21-digit sequence comprising a 16-digit credit card number, followed by a 4-digit expiration date (MMYY), followed by a 3-digit credit card verification (“CCV”) number, the sender message and the TAN 220 may be mapped to positions that are equivalent to these expectations using a process such as the following, it being recognized that any or all of the specific data elements herein mentioned could be changed to other variables: The least significant digit of the hour number representing the time of the transaction may be concatenated to the three-digit card issuer number, which may in turn be concatenated with a two-digit number representing the seconds at the time of the transaction. This number may in turn be concatenated to the ten-digit TAN to produce a sixteen-digit number. The sixteen-digit number may then be mapped to the location where the existing authorization apparatus would expect to read the card number data element. The two-digit month and two-digit year representing the time of the transaction may be mapped to the location where digits of similar length representing the expiration month and year respectively would appear. The two-digit date number representing the day of the transaction may be concatenated with the most significant digit of the hour representing the time of the transaction to produce a three-digit number, which may be mapped to the credit card verification (“CCV”) data element. Persons skilled in the art will appreciate that the mapping of the data representing issuer number, transaction time, and TAN onto the credit card standard card number, expiration date, and CCV may be done in a number of ways.

Finally, the sender message 206 and TAN 220 are joined in a step 222 to produce authorization data, which is saved in the card's memory. The smart chip may then read the authorization data and output 224 it to a programmable device emulating a static magnetic strip. The data output to the magnetic strip may be structured to be compatible with traditional credit card readers and transmission systems. The credit card may also have a magnetic strip bearing a static credit card number for use in places where there is no smart card reader present. The credit card data elements, including the authorization data, may also, or alternatively, be disclosed through a display disposed in the card so that the numbers may be read over the phone or input online.

Although the exemplary embodiment of the inventive method as shown in FIG. 2 utilizes a magnetic strip 224 to output the message 206 and the TAN 220, persons skilled in the art will, of course, recognize various other means for outputting this information for transmittal. For example, the cards could instead, or additionally, be equipped with radio-frequency identification (“RFID”) transmitters, allowing the card to simply be waved at a credit card reader instead of swiped through the reader. Transmission may also be accomplished through near field communication, a wireless Internet connection, Bluetooth technology, or any other communication protocol.

As noted above, FIG. 3 reflects the inventive method as it might be used for a credit card transaction from the point of view of the receiver 20. The exemplary process as shown in FIG. 3 includes a first step 302 wherein authorization data is read. The authorization data is the information sent by the sender 10 via the transmitter 30 as described with regard to FIGS. 1 and 2. The authorization data may be read by any method capable of transmitting digital data. For example, a computer network may be used, wherein the computer on the receiving end may utilize software instructions to read data from the network into the memory of the computer. In the exemplary embodiment, software instructions executing in a processor or other hardware may perform the functions comprising the steps in FIG. 3.

The second step 304 of the FIG. 3 embodiment is to split the authorization data into the sender message 206 and the TAN 220 received from the sender 10. The sender message 206 may comprise data elements such as cardholder name and/or the date and time of the transaction. Persons skilled in the art will recognize that the sender message 206 may include other data elements related to authorization of a transaction.

The third step 310 of the exemplary process is to hash the sender message 206 and produce a message digest 312. A PIN 306 and/or other optional data 308 may also be used in hashing. Persons skilled in the art will recognize that incorporating authorization data elements not received from the transmitter 30 may be desirable in the verification process; sending said data elements across a public transmission medium may pose an increased risk of fraud on future transactions. This third step 310 must use the same hash function 208 as the sender 10 who originally hashed the sender message 206.

The fourth step 314 is to encrypt the message digest 312, resulting in an encrypted digest 316. The method for encryption should be the same encryption method 214 used by the sender 10 to produce the authorization data 222. Additionally, the encryption should use the same secret key 212 as used by the sender 10. For added security, it is preferable that the secret key 212 itself not be transmitted to the receiver 20, but instead be stored in the files of the receiver 20. It is important to note that the process of FIG. 3 encrypts the sender message 206 rather than decrypting it. As previously discussed, persons skilled in the art will appreciate that a compressed cipher text cannot be decrypted because some information will have been lost. However its authenticity can still be verified by repeating the encryption procedure.

The process of FIG. 3 further includes the step 318 in which the encrypted digest 316 is compressed to produce a calculated TAN 320. This step 318 should use the same compression algorithm as used by the sender 10.

Upon producing the calculated TAN 320, the device executing the exemplary process then performs a comparison 322 to see whether the calculated TAN 320 matches the TAN 220 from the sender 10. If the two TANS 220, 320 match, then the final step is to approve the transaction 324. If there is no match, then the final step is to decline the transaction 326.

The inventive method may also be utilized through smart phones. Various smart phones, including the iPhone, Palm Treo, and Sprint Moto to name a few, already offer the ability to purchase credit card processing applications that allow the phones to take credit card payments and transmit them securely without add-on magnetic strip readers or other technology. Applications may be developed to allow the inventive method to be utilized on these phones in connection with credit or other secure transactions.

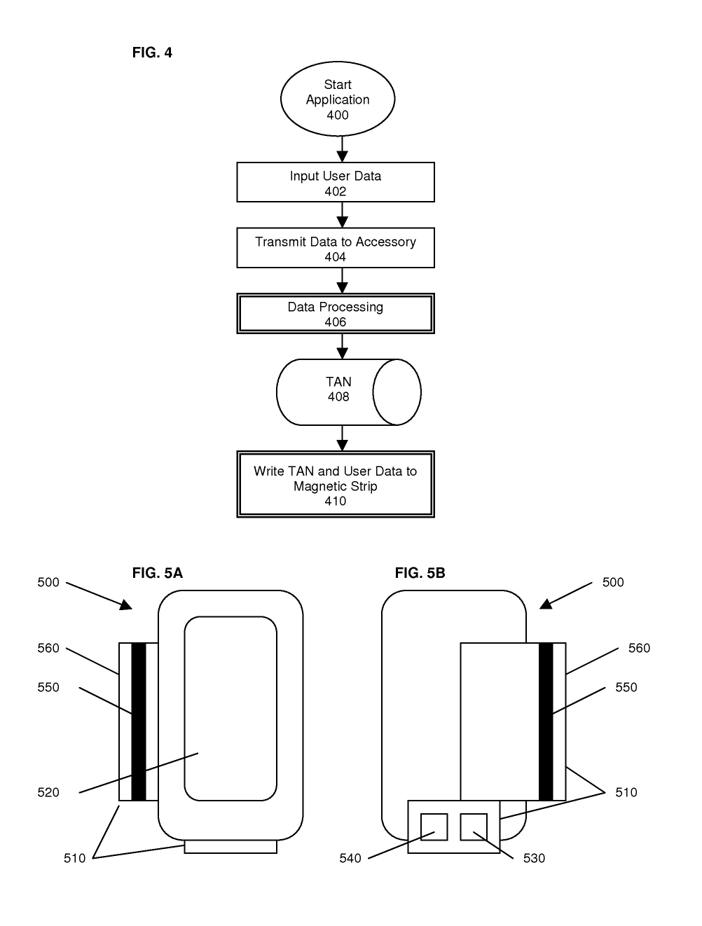

In the alternative, as shown in FIGS. 4, 5A, and 5B, an exemplary accessory 510 for an exemplary smart phone 500 may also be used to perform the inventive method and provide information to be output for use by standard card readers. In embodiments utilizing such an accessory 510 for credit transactions, the user will first utilize the smart phone interface 520 to start an application 400 to select a credit card for use. The application may require the input of user data 402, which may be one or more authentication means such as a PIN, other password, or even biometric information like a fingerprint, using the interface 520. This next step 404 would be to transmit the user data to the accessory 510, which comprises memory 530, a chip 540, and a programmable magnetic strip 550. The memory 530 preferably holds encryption keys for each of the user's credit cards. The chip 540 performs the next step 406 of data processing, which comprises performing the hashing, encryption, and compression process as previously described with respect to the inventive method, to produce a TAN 408. The accessory 510 then writes, at step 410, the TAN 408 as well as the other required user data onto the programmable magnetic strip 550, which may then be processed like any other credit card.

In some embodiments such as is shown in FIGS. 5A and 5B, a magnetic strip 550 may be disposed on a removable temporary credit card 560. The temporary credit card 560 could then be handed to a server in a restaurant without the user having to turn over his phone. In some embodiments, the application may provide a means for placing a limit on the temporary credit card 560 so that a child or employee may use the card.

There are several benefits to utilizing an accessory to perform the method instead of solely using an application. First, the accessory allows for reading of the necessary authorization information by standard card readers. Use of the accessory may also provide an additional security measure. For example, the accessory could be stored separately from the phone providing a physical barrier. Additionally, should a virus or malicious software compromise the security of the smart phone, the user's credit card information would not be reached.

Of course, other embodiments may utilize smart phones comprising one or more of a built-in protected memory, dedicated encryption chips, or magnetic strip emulators.

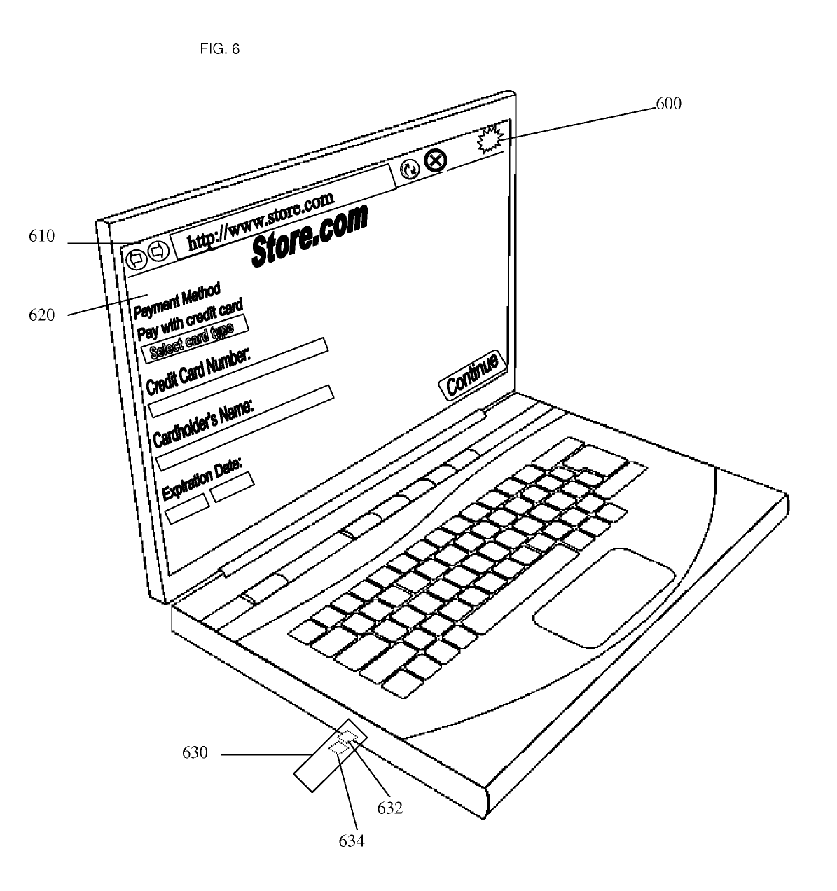

As depicted in FIG. 6, the inventive method may also be utilized for online transactions through the use of a plug-in 600 for a web browser 610 and a peripheral computer device 630, such as, for example as shown in FIG. 6, a universal serial bus (“USB”) key. When the exemplary plug-in 600 is activated, it gathers information from the web page 620 to identify the data sought to complete the transaction. The plug-in 600 then sends a request to the USB key 630, which contains both a chip 632 and protected memory 634. The chip 632 performs the hashing, encryption, and compression process as previously described with respect to the inventive method to produce a TAN, and the memory 634 stores the user's data, the encryption keys, and the algorithms necessary to complete the process. Once the TAN has been produced, the TAN and any other information sought by the web page 620 is sent back to the plug-in 600, which automatically fills in the field for the transaction. As with the smart phone accessory, the use of a USB key or other device 630 to store the user's data, encryption keys, and algorithms separately from a computer provides increased portability as well as increased security.

As mentioned above, the inventive method may be used in variety of ways not limited to credit transactions. For example, the method may be implemented in any security or identity card or device, from building access cards and to social security cards and drivers licenses. The method may also be used in place of an RSA SecurID token for even more secure authentication. Moreover, certain steps may be omitted in appropriate instances as will be recognized by those skilled in the art, without departing from the scope of the invention.

The foregoing details are exemplary only. Other modifications that might be contemplated by those of skill in the art are within the scope of this invention, and are not limited by the examples illustrated herein.

What is claimed is:

1. A method to process a user's transaction, comprising the steps of:
(a) Storing a private key in a first digital storage location wherein the private key is accessible upon request to a user;
(b) Storing the private key in a second digital storage location wherein the private key is accessible upon request to a receiver system, the receiver system comprising a processor and memory for storing data;
(c) Processing the user transaction to create a validation request, the processing comprising:
i. Generating a digital user message comprising user-identifying data and data relating to the user's transaction;
ii. Generating a first encrypted digest, wherein the step of generating the first encrypted digest further comprises:
1. Generating a first digital digest comprising at least a portion of the digital user message, and
2. Encrypting the first digital digest using the private key from the first digital storage location and an encryption program;
(d) Transmitting to the receiver system the validation request, the request comprising the digital user message and the first encrypted digest;
(e) Analyzing the validation request, the analysis comprising:
i. Generating a second encrypted digest, wherein the step of generating the second encrypted digest further comprises the following steps:
1. Processing the user-identifying information contained in the digital user message to identify the private key stored in the second digital storage location,
2. Generating a second digital digest comprising at least a portion of the digital user message, and
3. Encrypting the second digital digest using the private key from the second digital storage location and the encryption program;
ii. Comparing the first encrypted digest with the second encrypted digest.

2. The method of claim 1 wherein first digital storage location is identical to the second digital storage location.

3. The method of claim 1 wherein first digital storage location is distinct from the second digital storage location

4. The method of claim 1 further comprising determining whether the transaction is valid based on the results of the comparison.

5. The method of claim 1 wherein the user-identifying data comprises at least one of a portion of the user's name, a personal identification number, or a personal account number.

6. The method of claim 1 wherein the data relating to the user's transaction comprises at least one of data indicating the time of the transaction or data indicating the date of the transaction.

7. The method of claim 1 wherein:
(a) the step of generating a first encrypted digest comprises hashing the first digital digest, and
(b) The step of generating a second encrypted digest comprises hashing the second digital digest.

8. The method of claim 1 wherein:
(a) the step of generating a first encrypted digest further comprises compressing the encrypted first digital digest, and
(b) The step of generating a second encrypted digest further comprises compressing the encrypted second digital digest.

9. The method of claim 1 wherein:
(a) the step of generating a first encrypted digest further comprises selecting a portion of the encrypted first digital digest, and
(b) the step of generating a second encrypted digest further comprises selecting a portion of the encrypted second digital digest.

10. An integrated circuit card adapted for use by a user in a secure digital transaction, comprising:
(a) an interface configured to connect to a physical layer of an integrated circuit card terminal;
(b) a communication interface configured to communicate with a communication device; and
(c) an integrated circuit chip comprising:
i. control circuitry for managing operations of the circuit chip;
ii. a digital storage location for storing a private key;
iii. a communication interface connected to the control circuitry, the communication interface configured to communicate with a communication device and to receive data concerning the transaction from at least one of the user, a processor processing the transaction, and a digital storage location accessible by the circuit chip;
iv. a symmetric cryptographic processor, said processor being programmed to:
1. at a first point in time, generate a digital user message comprising user identifying information and data concerning the transaction,
2. at a second point in time, generate a first digital digest comprising at least a portion of the digital user message; and
3. at a third point in time, encrypt the first digital digest using the private key and an encryption program; and
4. at a fourth point in time, transmit the encrypted digital digest and the digital user message to a receiver in a manner that permits the receiver to
a. locate the private key and the encryption algorithm,
b. use the private key and the encryption algorithm to create a second encrypted digital digest, and
c. use the second encrypted digital digest to determine whether the transaction is authentic without decrypting the first digital digest.

11. The integrated circuit card of claim 10 further comprising at least one of a time-signal generator or a date-signal generator.

12. The integrated circuit card of claim 10 further comprising a device capable of emulating a magnetic strip and wherein the message and the encrypted digest are mapped to the magnetic strip device.

13. The integrated circuit card of claim 10 further comprising a smart phone housing the integrated circuit card.

14. The integrated circuit card of claim 10 wherein the communication device transmits information using a communication protocol selected from the group consisting of radio-frequency identification, near field communication, wireless Internet connection, and Bluetooth technology.

15. A smart phone adapted for use by a user in a secure digital transaction, comprising:
(a) control circuitry for managing operations of the smart phone;
(b) a digital storage location for storing a private key;
(c) a communication interface connected to the control circuitry, the communication interface configured to communicate with a communication device and to receive data concerning the transaction from at least one of the user, a processor processing the transaction, and a digital storage location accessible by the smart phone;
(d) a symmetric cryptographic processor, said processor being programmed to:
i. at a first point in time, generate a digital user message comprising user identifying information and data concerning the transaction,
ii. at a second point in time, generate a first digital digest comprising at least a portion of the digital user message; and
iii. at a third point in time, encrypt the first digital digest using the private key and an encryption program; and
iv. at a fourth point in time, transmit the encrypted digital digest and the digital user message to a receiver in a manner that permits the receiver to
1. locate the private key and the encryption algorithm,
2. use the private key and the encryption algorithm to create a second encrypted digital digest, and
3. use the second encrypted digital digest to determine whether the transaction is authentic without decrypting the first digital digest.

16. A system for validating a transaction, the system comprising a sender, a transmitter, and a receiver;
(a) the sender having a device;
i. the device having a first at least one processor and at least one digital storage location;
ii. the at least one digital storage location storing a first private key and a first encryption algorithm;
iii. the first at least one processor being programmed to:
1. at a first point in time, generate a message comprising data identifying the sender and data concerning the transaction;
2. at a second point in time, generate a first digital digest comprising at least a portion of the message; and
3. at a third point in time, encrypt the first digital digest using the first private key and the first encryption program, to create a first encrypted digest;
(b) the device having an interface programmed to communicate the message and the first encrypted digest to a transmitter;
(c) the transmitter being equipped to send and receive information from the sender and the receiver;
(d) the receiver comprising:
i. a device adapted to receive the message and the first encrypted digest from the transmitter;
ii. at least one digital storage location, the at least one digital storage location storing a second private key and a second encryption algorithm, said second private key being operatively identical to the first private key and said second encryption algorithm being operatively identical to the first encryption algorithm;
iii. a second at least one processor, the second at least one processor being programmed to:
1. at a first point in time, generate a second digital digest comprising at least a portion of the message;
2. at a second point in time, encrypt the second digital digest using the second private key and the second encryption program to create a second encrypted digest; and
3. at a third point in time, compare the first encrypted digest with the second encrypted digest.

17. A method for validating a transaction, comprising:
(a) storing a private key in a receiver-accessible digital storage location within a receiver system, the receiver system comprising a processor and memory for storing data;
(b) receiving a user message and an encrypted user digest that comprises at least a portion of the user message, encrypted using the private key or a duplicate of the private key, and an encryption algorithm,
(c) generating an encrypted receiver digest, wherein the step of generating the encrypted receiver digest comprises the following steps:
i. obtaining from the user message information necessary to identify the private key;
ii. retrieving the private key from the receiver digital storage location;
iii. generating a digital digest comprising at least a portion of the user message;
iv. encrypting the digital digest using the private key and the encryption program; and
(d) comparing the encrypted sender digest with the encrypted receiver digest.
